(19) United States
(12) Patent Application Publication
(10) Pub. No.: US 2026/0030659 A1
(43) Pub. Date: Jan. 29, 2026

(54) Novel systems and methods for donor focused advertising and marketing for nonprofits with integrated nonprofit functions such as fund raising, donor engagement and direct participation by users (donors and potential donors).

(71) Applicant: Indumathi R. Subramaniam, Fishers, IN (US)

(72) Inventor: Indumathi R. Subramaniam, Fishers, IN (US)

(73) Assignee: i-Apps LLC, Fishers, IN (US)

(21) Appl. No.: 16/914,295

(22) Filed: Jun. 27, 2020

Related U.S. Application Data
(60) Provisional application No. 62/839,627, filed on Apr. 27, 2019.

(51) Int. Cl. G06Q 30/0279; G06Q 30/0201; G06Q 30/0241

(52) U.S. Cl. CPC G06Q 30/0279; G06Q 30/02012; G06Q 30/0241

(57) ABSTRACT

The proposed solution will provide a service platform that will create an environment to bridge the various gaps that exist currently between donors and nonprofits. The invention sets itself apart from existing approaches available in todays' market. The invention offers a unique two way integrated solution. Nonprofits get dynamic marketing solution based on donor preferences and sentiments, and the ability to engage in contextual communication with donors—with nonintrusive donor engagement and fundraising embedded capabilities. Donors gain progressive transparency with access to nonprofit and charitable organization information, exercising their preferences, interests and sentiments in making choices.

The goal of the invention is to positively influence the use and behavior of 1. donor approaches and donor attitudes to giving and 2. Nonprofit and charitable organizations towards donors. It seeks to leverage various technology solutions to accomplish this.

A novel systems and methods for donor focused advertising and marketing for nonprofits with integrated nonprofit functions such as fund raising, donor engagement and direct participation by users (donors and potential donors).

### BACKGROUND OF THE INVENTION

While historically nonprofits were originally established specifically for human necessities and to alleviate human suffering over the last few decades a growing number of nonprofits have been established that address many other areas of interest. It has therefore become important for nonprofits to raise money to support their causes while competing with each other for donor dollars.

With the proliferation of advertising and marketing strategies, individual's interests and compulsive tendencies are being leveraged to maximize buyer spend. Nonprofits need to compete in this environment for the same dollars and their tasks become even more difficult as they have nothing tangible to give in return. What they often have to offer are altruistic sentiments and an appeal to mankind's better instincts.

Today there are many disparate methods for nonprofit and charitable organizations for advertising, fundraising etc. Some key issues, that exist today, involve the methods and techniques used for advertising and marketing, fundraising and keeping alive donor interest.

The individual donors on the other hand are generally left without much information about
a. what's out there that meet their interest or
b. finding avenues that appeals to them to express their altruistic sentiments or
c. for making choices that influence betterment of life, in whatever small way.

Research has shown that generally donors, on an average, spend about $450/annually on charitable donations. Research also shows that individuals spend more time researching for a $75/-shoe than they do for where their precious dollars should go.

There are seldom simple and easy methods to capture donor choices and preferences and hence no way to target those preferences and choices. Soon there develops a lack of interest and then commitment fades.

The proposed invention creates an environment that will help both nonprofits and donors bridge the various gaps that exist today and sets itself apart from existing approaches and available solutions.

### BRIEF SUMMARY OF THE INVENTION

The first ever donor focused integrated marketing and advertising platform for nonprofits and charitable organizations.

Donors get easy access to nonprofit information, can record preferences and interests, be actively engaged, access one click donation and much more.

Various gaps exist in current solutions which this invention tries to address:
Do not capture donor preferences or sentiments
Are siloed making giving unattractive and difficult for donors
Information is not easily accessible.
No focus on maintaining donor interest
No easy mechanism for active donor participation.
Donors left with a feeling of lack of transparency

The invention looks to change the way giving takes place by achieving
Democratization of Donor Base
Singularity of Giving
One click donation
Donor Personalized and Targeted Marketing & Advertising
Contextual Communication
Strong donor participation and engagement
Resounds with Gen X, Y and Z

### DESCRIPTION OF THE SEVERAL VIEWS OF THE DRAWING

FIG. 1—A high level description of the inventions data acquisition process

FIG. 2—A cloud computing diagram. The invention will use various aspects of cloud computing as part of its solution development and implementation

FIG. 3—A drawing showing concept of Internet of things and in context of this invention also internet of everything. The invention adopts the principles of Internet of things/everything

FIG. 4—A drawing showing some important interaction points between the users and nonprofits/charitable organizations with the invention

FIG. 5—This figure shows the marketing and advertising granularity concept

FIG. 6—This is a figurative depiction of embedding various nonprofit functions as functionality capsules within the marketing and advertising done by nonprofit organizations

### DETAILED DESCRIPTION

The terms, system, service, platform, service platform, invention, are all often used interchangeably throughout this description unless it clearly refers to something else in this detailed description document. Similarly, the terms users and donors (including potential donors) are interchangeable. The term nonprofit also refers to charitable organizations.

The following are detailed descriptions, which provides specific details, help in the understanding of the invention.

### I. Points to be Noted

1. There are a plurality of technical methods and/or processes and technological adoptions that are possible for this invention. Therefore, there is no specific mention here to any specific such one method/process or specific technology. For that same reason, only some embodiments implementing the invention will be described here.
2. It should be understood that the system described here, is largely in terms of capabilities and features that the invention provides. The invention has been conceived in such a manner, that it affords the capabilities and features for adopting a plurality of methods and technologies. The invention has the ability and flexibility to do so.
3. It should be understood that the description presented here maybe largely in terms of some computer and technology just for understanding and is only indicative and should not be interpreted as being able to use or adopt only these. The deployment may use more or less of the components described and may also utilize additional components not mentioned here as per the specific deployment requirements. Also, no specific localization of these components is intended to be denoted here.
4. It's important to keep in mind that all processes and methods cannot be described here. The invention has been designed in such a way as to provide flexibility in deployment based on components and methods adopted coupled with flexibility of technology adoption.

### II. Invention Key Components and Methods

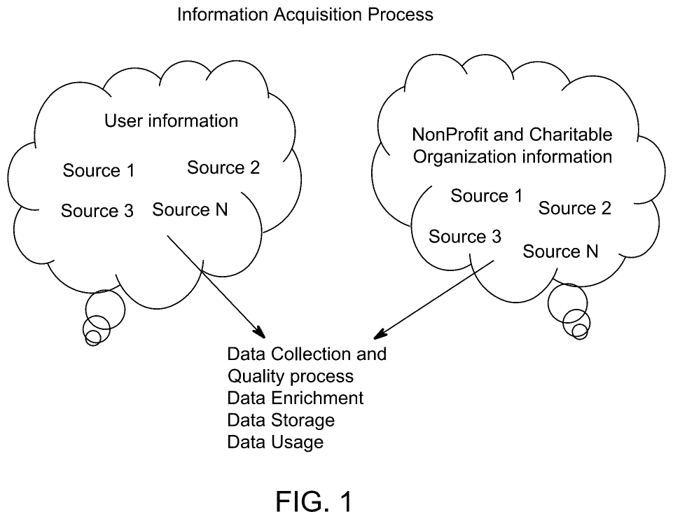

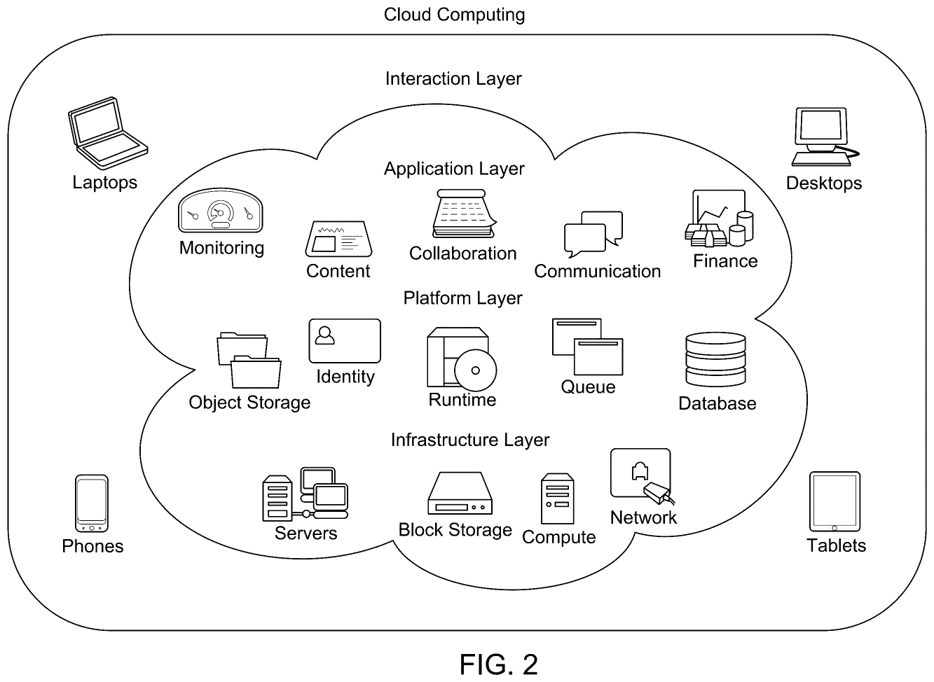

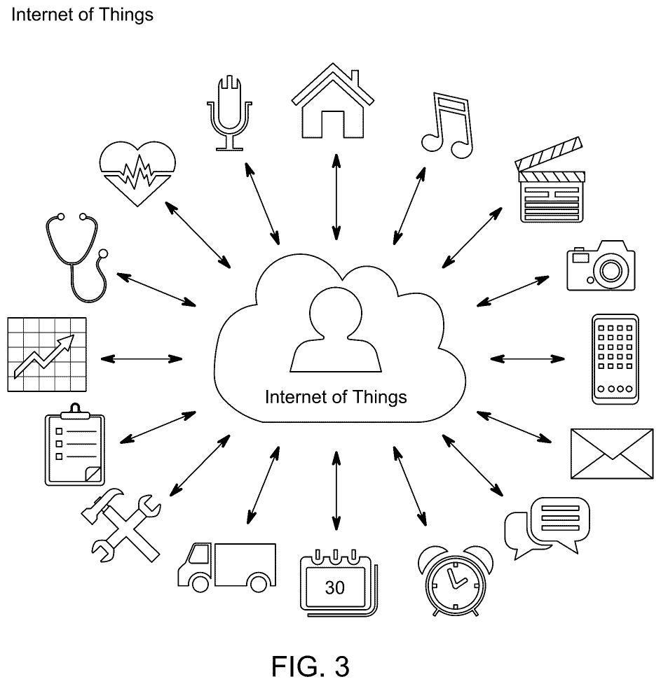

1. The invention supports a plurality of sources of data as part of its strategy. Using these various methods, the invention builds profiles of nonprofit and charitable organization.
   It will collect the information in various ways including raw data formats, which can come in multiple formats such as normal formats like text files, csv, pdf, word documents etc. It may also source information other more complex digital formats or database files and various unstructured sources.
2. The system will then let the data pass through a series of quality assurance processes to distil information as required for the system. Data enrichment mechanism will be provided to bring the data to the necessary state. In addition, the system may also acquire data that is directly inputted by the nonprofit and charitable organizations and users of the service platform.
3. The system will also construct and maintain donor profiles in a similar fashion. The above three processes are captured in FIG. 1.
4. The system will then reformat and store the information for use by the platform. The system also will periodically update the data to retain currency and accuracy of the data. Data used by the system may reside in memory or off memory. Data can be stored in offline as well as online modes as determined by the system and deployment requirements.
5. The system is designed to operate on a device independent fashion and can be deployed on any platform. In addition, the invention will be in a position to adopt cloud-based solutions. Some examples are SAAS, PAAS, JAAS etc. Cloud computation in the context of this invention will also include adopting a group of networked elements providing services that do not need to be individually addressed or managed by users; instead, the entire provider-managed suite of hardware and software can be thought of as an amorphous cloud. It will provide capabilities for on-demand self-service. As an example-unilaterally provision computing capabilities, such as server time and network storage, as needed automatically without requiring human interaction with each service provider. See FIG. 2.
6. The invention also makes use of IoT and/IoE (Internet of Things/Internet of Everything) principles to implement various capabilities and services offerings. In “How Stuff Works”, Dr. Bernadette Johnson—the Chief Technology Ventures Officer at MIT Lincoln Laboratory has said “The Internet of Things (IoT), also sometimes referred to as the Internet of Everything (IoE), consists of all the web-enabled devices that collect, send and act on data they acquire from their surrounding environments using embedded sensors, processors and communication hardware. These devices, often called “connected” or “smart” devices, can sometimes talk to other related devices, a process called machine-to-machine (M2M) communication, and act on the information they get from one another. Humans can interact with the gadgets to set them up, give them instructions or access the data, but the devices do most of the work on their own without human intervention”. See FIG. 3.
7. For the purpose of this invention IoE concepts such technology (machine-to-machine (M2M)), people (technology-assisted people-to-people (P2P)) and processes ((machine-to-people (M2P)) interactions are within its solution realm. “The Internet of Everything (IoE) is bringing together people, process, data, and things to make networked connections more relevant and valuable than ever before, turning information into actions that create new capabilities, richer experiences, and unprecedented economic opportunity for businesses, individuals, and countries.”, (Cisco, 2013).
8. In the context of this invention various embodiment of all the technology embodiments described in 6 and 7 are used. The usage of these technological features is based on the context and actions that are performed by the invention.
9. Some components of the invention that will be required are at least one form of user interaction device by which the uses will be able to interact with the system. This interaction can be achieved in a plurality of ways. Similarly, the non-profit and charitable organizations may choose an interface to directly interact with the system,
10. The system itself can use WAN, LAN, Ethernet or any other form of wireless or wired networking systems as available.
11. Data storage, servers and memory components are also a required part of the system. The invention will also provide for social media integration. There will be a plurality of social media integrations. Users may use one or more of these integrations. Usage of these social media integrations are optional. Similarly, Nonprofits too have an option of using such integrations but it is not required to do so.
12. The invention will adopt the principle of device and location independence.
This list of components and methods is just indicative and not supposed to be exhaustive in any manner. It is a means of understanding some of the possible components and methods that would be required.

### III. Interaction Flow

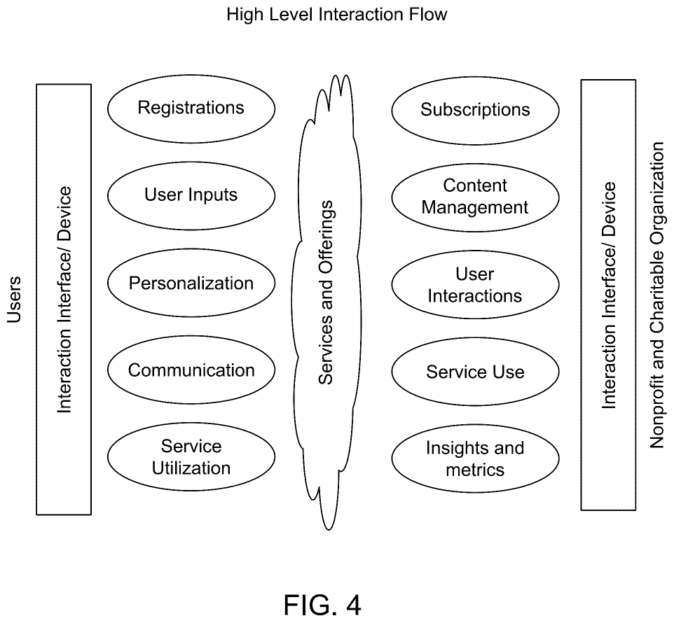

High Level Interaction Flow is described here and this flow is illustrated in FIG. 4. It is to be kept in mind that this is not comprehensive list of the whole system working but of the interaction points and captures only some of the key points of user and non-profit/charity interactions with the system.
1. Product Installation and Setup for Nonprofit and charitable organizations
2. Nonprofit and charitable organization information enters the system
3. Various offerings are provided to the nonprofits
4. Nonprofit and charitable organizations subscribe to these offerings
5. Nonprofit and charitable organizations add, modify and remove content
6. Product Download/Installation by users
7. User enter/become active on the system
8. The invention will process user information and is ready to communicate with user
9. User can indicate their preference and interests
10. Users start using the various services provided by the invention
11. Users create personalized content
12. Various user related features are provided for users
13. Users interact with nonprofits and charitable organizations using the invention's various features
14. Users can track various interaction they have within the invention
15. Users may interact with other users
16. Nonprofits interact with users directly or indirectly
17. Nonprofit and charitable organizations able to track metrics related to activities
18. User can leave and re-enter as desired
19. Nonprofit and charitable organizations leave and re-enter as desired.

### IV. Invention Features

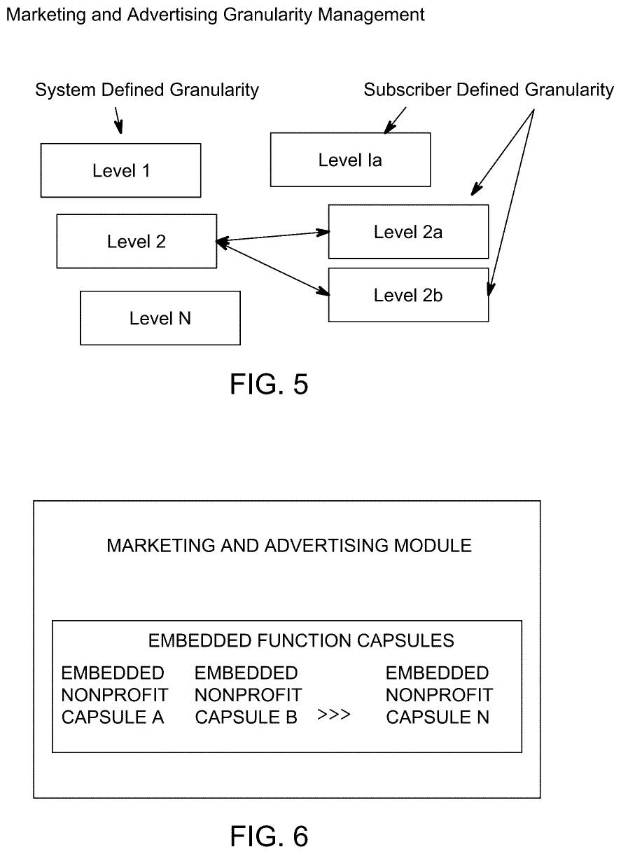

1. The service platform will have provisions by which it will allow nonprofits and charitable organizations to subscribe to the platform's services. The system will have the ability to then capture information about the subscription of the nonprofit and charitable organizations as well as any options selected and store this information within the system. These subscription types will then be used to determine the level and type of participation that will be offered to the subscribers as well as amount and type of content that the system will accommodate for the subscriber. The system will also provide the capability to terminate, upgrade and downgrade nonprofit subscriptions.
2. The platform provides for various intake mechanisms whereby nonprofits and charitable organizations can provide new content as well as manipulate their existing content. The system will allow for content, personalized to be needs of the nonprofit or charitable organization to be put on the platform. Further capabilities will then be provided for the organizations to put content on a hold status as well as remove its content.
3. The invention will provide features through which the nonprofit and charitable organizations can advertise and market themselves. The system will offer progressively more granular layers of such advertising and marketing capabilities right from a high level to a more detailed level. This granularity is both enforceable in part by the system and in part will also be determined by the nonprofit and charitable institutions themselves based on their needs. However, the granularity adoption is optional and not mandatory. This process is captured in FIG. 5.
4. The marketing and advertising content supported within the service platform will support static and/or dynamic content and will cover both digital and digitizable information, including audio and video content. In addition, nonprofit and charitable organizations can run their campaigns on this service platform.
5. The platform will provide capabilities for posting information about events and programs being organized by the charitable and nonprofit organizations. These programs and events may be free or paid/ticketed as determined by the organization. The system will have capabilities to address both of these situations.
6. The invention will allow nonprofits and charitable organization to seek volunteers both skilled and unskilled through capabilities of the platform. The system will provide the ability for nonprofits and charitable organization to solicit volunteers. The subscribers in addition will have the capability to post volunteer requirements at different granular level that is appropriate for them. This capability can be offered as an embedded functionality capsule. See FIG. 6.
7. The invention will also have fundraising capabilities. The fundraising capabilities of the invention will provide support for both spontaneous giving as well as for deliberate, scheduled giving. Another feature of the fundraising capability of the invention is providing capabilities for “simultaneous fundraising”, wherein the service platform allows for fundraising to occur while nonprofits are advertising and marketing their causes or posting events/programs. Refer to FIG. 6
8. The invention will be able to embed various nonprofit functionality through function capsules. These function capsules are embedded with the marketing and advertising modules of nonprofit. Refer to FIG. 6
9. The invention will allow users to access the system and participate through computer, mobile and other digital media sources. The system provides methods for logging in and logging out of users. In addition, the users will be able to register into the system to tap into value-add offerings. The system also provides for multiple ways of registering to the service platform
10. The system will provide methods for users to search and access information about nonprofits and charitable organization. The system will have the ability to have some predetermined built-in search criteria. The system will have location information to modify the information access of users if they so desire. Provision for overriding this will also be provided to users. In addition, for search purposes, users will be provided capabilities to input criteria of their own choice for conducting their search. Users will be provided options for saving their choices.
11. Users will be provided with capabilities to view and review advertising and marketing materials. User inputs and reactions will be captured. The system will have capabilities whereby users/donors can voluntarily participate in promoting what they like. These promotions can be done at various levels and in more than one way. In addition, through Direct Chain Marketing (a unique concept) users will be given opportunities to recommend and promote specific thing that they see or like within the system. “DC Marketing” is not the same as Network Marketing, Pyramid marketing or multi-level marketing. The invention will provide capabilities for users to share what they liked and their activities with others.
12. The invention will allow users options for making monetary donations as well non-monetary donation in terms of time and effort. Efforts could be both skilled or unskilled.
13. Feedback mechanisms within the service platform will support acknowledgement of donations received. The users will be provided the ability to make immediate contributions or future contributions.
14. The system will offer capabilities for the users to register and participates in events and programs made available by nonprofit organization. The users will also be provided capabilities to record these in a calendar option. Also, where registration details are required, prefill capabilities may be provided with options to override.
15. The invention has the ability to capture user indicated items of interest. These indications come from a variety of ways including direct and indirect indications.
16. The systems will collect preferences from users via a number of ways, which includes direct user inputs as well as indirectly. In addition, the invention will be able to extrapolate and collect additional information apart from what was originally provided.
17. Similarly, user personalization's and interests will also be collected. These are not just based on entered data or given data but will employ numerous methods and techniques including but not limited to data analytics, AI, predictive analytics, behavior analytics etc.
18. The system will have the capability of offering information and content based on the interests, inclinations and personalization's of the users.
19. The invention will allow users to monitor their giving and charitable activity by providing a personal dashboard. The personal dashboard will allow the users to gain information into their various activities and system interactions. Samples of such information could be donations, volunteering and other activity details.
20. The invention also will have the ability to communicate with users and subscribers via notifications and other forms of communications. Users and subscribers will have the ability to exercise preferences in notifications. Peer to peer communication will also be supported in many different ways such as notifications, emails, social media etc. System generated notifications will also be a feature of this invention.
21. The users will be provided options for indicating what they favor at various points-right from an organisation level to more detailed levels. Similarly, they will be given the capability to record what they Like. The system will have the ability for user to modify whatever they have recorded.

1. The invention claims that its system has the capability to positively influence and change the giving behavior of donors. It does this by some unique capabilities it adopts listed below. It should be noted that this proposition is unique as they are currently not available to donors or nonprofits as a combined offering.
a. Providing a greater level of transparency to donors about nonprofits and
b. Aiding information availability and consumption of the information by donors.
c. By the service platform being device independent and location independent
d. The invention will also support spontaneous giving and collection of micro donations
e. Allowing the donors and potential donors to indicate their preferences and interests. This is a dependent claim on claim 1.
f. Ability to make choices based of their expressed preferences and interests. This is a dependent claim on claim 1.

2. The invention provides an integrated donor focused marketing and advertising platform. Integration happens in two ways. One—integrating Donors with nonprofit marketing and advertising components. Two—integrating Marketing and Advertising with other nonprofit functions such as donor engagement and fundraising etc. Currently there are no platforms serving the non-profit industry, that are providing this sort of integration. The system achieves this through some unique components as listed below:
Nonprofit Function Integration Points
a. Fundraising aspect of the invention is unique in that it provides capabilities for “simultaneous fundraising”, where the system allows for fundraising to occur while nonprofits advertise their causes or post events/programs or solicit volunteers or request for participation. The invention is able to do this through a feature which it entitles as “Embedded giving process”. This is a unique feature that is being created by the invention. By this, the invention will embed fundraising capsules into the advertisement/marketing capabilities so that nonprofits can achieve both functions together.
b. The system will have capabilities for building intelligence into the giving and receiving patterns. The invention will support in-built predictive and deductive capabilities apart from CRM (Customer Relationship Management) type functions that will discover propensity of users for making donations. In todays' market, there is little by way of which nonprofit can discern what are the donor interests, if their interests are changing, or they are on the fence to cause etc. However, with the inventions ability to integrate donors with nonprofits this insight is now available for nonprofits to sell their causes. This is a Dependent claim on claim 1.e) and 1.f) and claim 2
c. The invention has the ability to link the marketing and advertising by nonprofits with donor engagement functions. It does this in a seamless and frictionless way—through a feature that this invention introduces called “Embedded donor engagement”. Within the marketing and advertising that the nonprofit puts out there are embedded functionality capsules that will allow for immediate and direct engagement by donors with nonprofits and their events and programs. Dependent claim on claim 2
Donor-Nonprofit Integration Points
d. The invention is unique in that it has the capability to capture donor personalization. Currently nonprofits have little to create personalized messages and it stops at Name, address, birthdays or anniversary. i2—Donate has the ability to capture donor preferences and interests and using multiple methods and in multiple ways that will include among other things machine learning, data analytics, heuristics and behavioral analytics. This information could then be used by nonprofits to develop targeted personalized messages. This is a Dependent claim on claim 1 and claim 2
e. As another way for integrating donors and nonprofits, the invention is creating a new concept that we call “Direct Chain Marketing” or “DC Marketing”. This in no way should be confused with network marketing. When nonprofits advertise and market their causes the platform allows for furthering their causes using donor links to further advertise/market themselves. This is not restricted to just the cause alone, but can also be extended to various events or programs. Each such promotion is called a chain and can have 1 or more donor links. The donor link in turn could be participating in just one chain or multiple chains. Such Direct Chain Marketing or “DC Marketing” is purely voluntary and will not be mandated by the system. This is a Dependent claim on claim 2
f. Another integration that the service platform provides is that this invention provides an integrated mechanism for combining advertising and marketing with seeking volunteer opportunities, requesting for volunteers and receiving volunteer offers from donors. This is a Dependent claim on claim 2

3. The invention also provides some new marketing and advertising paradigms (over and above the integrations mentioned above) so far not offered and available to the nonprofits.
a. Support for marketing and advertising granularity. The invention provides nonprofits the option to advertise at various levels. The nonprofits could have a hierarchy and build levels in their marketing and advertising strategy. Something that no marketing mechanism is able to do today. These hierarchies are partly system driven and partly driven by the nonprofit themselves. This is a Dependent claim on claim 3
b. Currently the way nonprofits advertise is through some medium such as billboard, printed matter, telemarketing, television etc. However, in all of these cases the nonprofits are generally restricted to one method via one medium. For example, if they choose to advertise by billboard then display is their option. If its telemarketing then it is just a voice marketing their cause. The invention on the other hand will have the capability to allow for a plurality of mediums and methods from visual display to audio and video methods. The nonprofit has the ability to select one or more of these marketing mediums. This is a Dependent claim on claim 3
